(19) United States
(12) Patent Application Publication
(10) Pub. No.: US 2009/0193152 A1
(43) Pub. Date: Jul. 30, 2009

(54) EXTERNAL DEVICE WITH A DRIVER AUTO-RUN INSTALLATION AND METHOD THEREOF

(76) Inventors: Ting-Chun Wang, Tainan County (TW); Jui-Chu Peng, Hsinchu City (TW); Kuo-Pin Chiou, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/264,233

(22) Filed: Nov. 3, 2008

(30) Foreign Application Priority Data
Jan. 30, 2008 (TW) 097103428

(51) Int. Cl. G06F 3/00

(52) U.S. Cl. 710/8

(57) ABSTRACT

An external device includes a controller, a connector, a function circuit, and a storage device. The storage device stores firmware and an image file. The image file includes an installation program and a driver. The external device is coupled to a host via the connector. The firmware can drive the controller to generate a virtual optical disc drive in the host and load the image file to the virtual optical disc drive so as to start the installation program. When the host does not have the driver, the installation program can install the driver in the host. When the host has the driver, the host can drive the function circuit to work.

### BACKGROUND OF THE INVENTION

1. Field of the Invention

The present invention relates to an external device of a computer, and more particularly, to an external device with a driver auto-run installation.

2. Description of the Prior Art

At present, most external devices, e.g. printers, scanners, modems, wireless network cards, and peripheral devices, are designed to be plug-and-play. However, most external devices are not standard devices directly supported by the computer, so users usually purchase the external device packaged with a CD or a floppy storing a driver of the external device. When installing the driver of the external device, users may insert the CD into the computer, so that the computer can read the driver stored in the CD, and then follow the instructions step-by-step to complete the installation, which are often trivial procedures. The plug-and-play external devices are convenient for use, but if the CD with the driver is lost, the external device probably cannot be used.

Most optical disc drives support an auto-run mechanism. When the user uses the CD to install the driver of the external device, the optical disc drive executes a program stored in the CD automatically when the CD is inserted into the optical disc drive, and then starts the steps of the installation. In general, the auto-run mechanism is based on a description file (AUTORUN.INF) stored in the CD. According to the description file, the computer can proceed to execute the program or open files. If the optical disc drive does not support the auto-run mechanism, or the CD does not have the description file, the user may command the computer to install the driver of the external device.

In conclusion, when adding the external device to the computer, the user needs to install the driver of the external device, and they usually use the CD or floppy of the driver to perform the installation. Most optical disc drives now support the auto-run mechanism, so it is not difficult to install the driver. However, if the user loses the CD or floppy of the external device, the external device probably cannot be used, or the user may need to find the driver on a website of the vendor. In addition, if the user wants to use the external device at other computers, they need to install the driver of the external device on the computers with the CD or floppy having the driver. Thus, the user has to have both the external device and the CD with the driver so as to use the external device at other computers. It is very inconvenient when using many portable external devices.

### SUMMARY OF THE INVENTION

According to an embodiment of the present invention, an external device with a driver auto-run installation, the external device comprising: a connector for coupling to a host; a function circuit for providing a predetermined function to the host; a storage device comprising an image file, the image file comprising an installation program; and a controller coupled to the connector, the function circuit, and the storage device, for generating a virtual optical disc drive on the host, and loading the image file to the virtual optical disc drive for executing the installation program.

According to another embodiment of the present invention, a method of installing a driver of an external device, comprising: coupling the external device to a host; generating a virtual optical disc drive in the host; the host reading an image file stored in the external device with the virtual optical disc drive; providing an installation program in the image file; and the host executing the installation program for installing a driver of the external device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an external device coupled to a host according to the present invention.

FIG. 2 is a block diagram of the external device according to the present invention.

FIG. 3 is a flowchart of driver auto-run installation of the external device according to the present invention.

### DETAILED DESCRIPTION

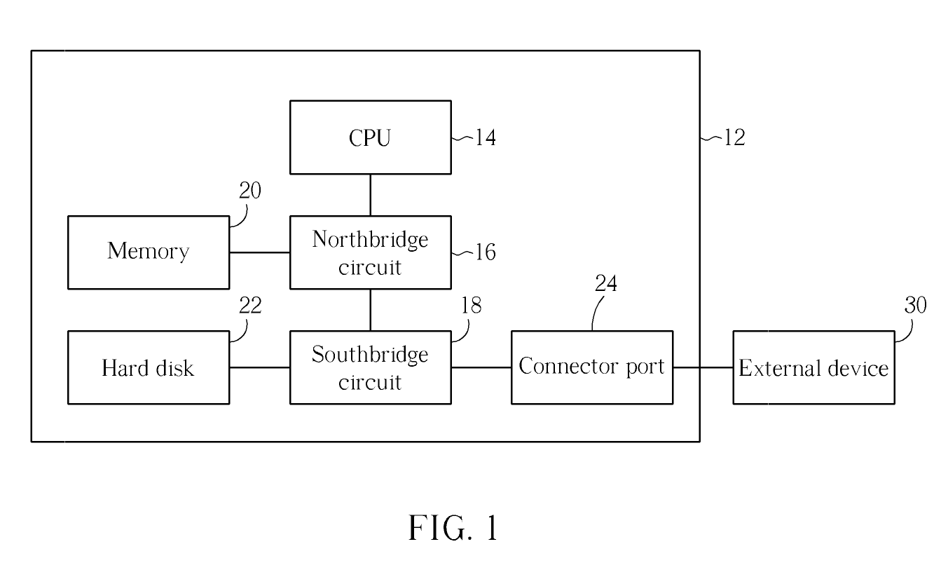

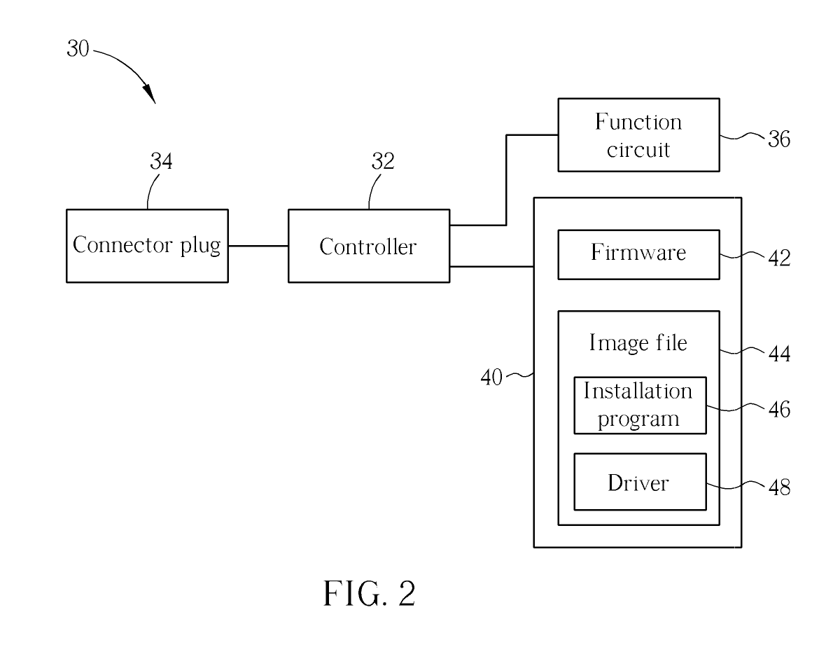

Please refer to FIG. 1 and FIG. 2. FIG. 1 is a block diagram of an external device 30 coupled to a host 1 2 according to an embodiment of the present invention. FIG. 2 is a block diagram of the external device 30 according to an embodiment of the present invention. The host 12 comprises a CPU 14, a northbridge circuit 16, a southbridge circuit 18, a memory 20, a hard disk 22, and a connector port 24. The north bridge circuit 16 controls the signal transmission of the memory 20 and the CPU 14. The south bridge circuit 18 controls signal transmission of the hard disk 22, the connector port 24, and the northbridge circuit 16. The external device 30 is coupled to the host 12 through the connector port 24, e.g. a USB port or an IEEE 1394 port. When the host 12 starts an operating system, the operating system loads the drivers from the hard disk 22 according to the hardware installed in the host 12, so that the operating system can drive the hardware to work. When the external device 30 is coupled to the host 12 for the first time, the external device 30 is a newly added hardware to the host 12. The driver of the external device 30 has to be installed in the hard disk 22, so that the operating system can drive the external device 30. According to the present invention, when the external device 30 is coupled to the host 12, the external device 30 can check if the drive has been installed in the host 12. If the driver of the external device 30 is not installed in the host 12, the external device 30 can install the driver automatically.

As shown in FIG. 2, the external device 30 comprises a controller 32, a connector 34, a function circuit 36, and storage device 40. The connector 34 is used to couple the connector port 24 of the host 12, such as, but not limited to, a universal serial bus (USB) interface or an IEEE 1394 interface. The controller 32 is coupled to the function circuit 36 and the storage device 40. The controller 32 controls the data transmission and the driving voltages of the function circuit 36 and the storage device 40. In the embodiment of the present invention, for example, the external device 30 can be a wireless network card, and the function circuit 36 can be a wireless module for outputting and receiving RF signals and accessing a network through a wireless transmission. In addition, the storage device 40 can be a non-volatile memory for storing firmware 42 and an image file 44. The image file 44 comprises an installation program 46 and a driver 48. The firmware 42 can drive the controller 32 to generate a virtual optical disc drive in the host 12, and load the image file 44 to the virtual optical disc drive. Thus, the host 12 can execute the installation program 46 with the auto-run mechanism so as to install the driver 48 of the function circuit 36.

When the external device 30 is coupled to the host 12, the firmware 42 can drive the controller 32 to generate a virtual optical disc drive in the operating system of the host 12. Then, the operating system of the host 12 uses the virtual optical disc drive to read the data of the image file 44. When the image file 44 comprises a description file (AUTORUN.INF) or an auto-execution file (AUTORUN.EXE), the operation system of the host 12 can read the data of the image file 44 according to the description file or the auto-execution file. Thus, if the auto-execution file is set to the installation program 46, or the description file has a pointer pointing to the installation program 46, the installation program 46 can install the driver 48 of the function circuit 36 to the host 12.

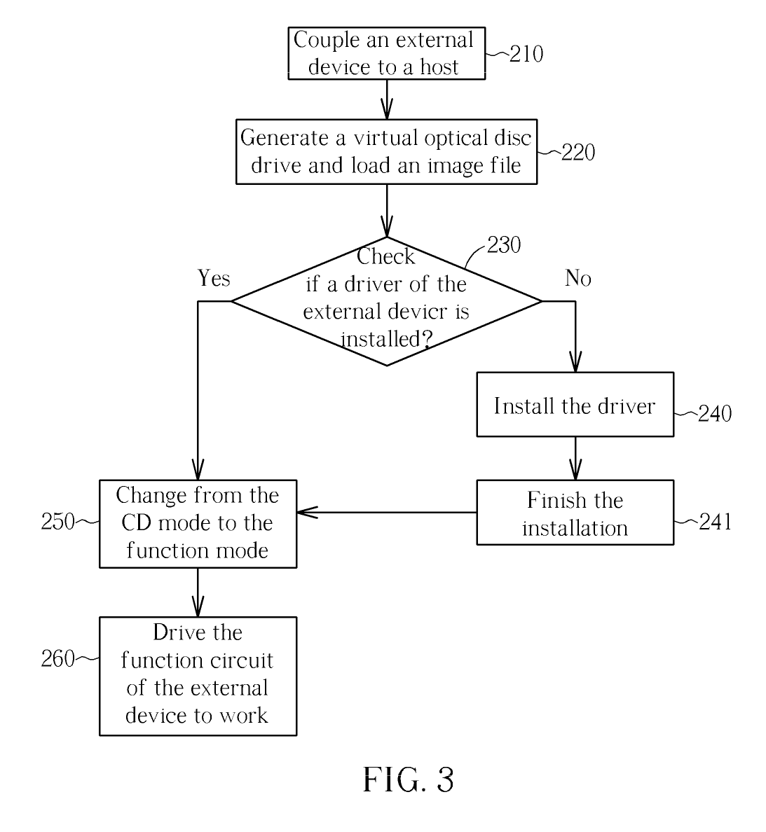

Please refer to FIG. 3. FIG. 3 is a flowchart of the driver auto-run installation of the external device according to the present invention. The steps are illustrated in the following:

Step 210: An external device is coupled to a host.

Step 220: A controller of the external device responds to an operating system of the host so as to generate a virtual optical disc drive and then load an image file.

Step 230: The external device checks if a driver of a function circuit is installed in the operating system. If the driver is not installed, go to Step 240; if the driver is installed, go to Step 250.

Step 240: The operating system executes the installation program of the image file so as to install the driver of the function circuit.

Step 241: The operating system finishes the installation program for the driver of the function circuit.

Step 250: The external device changes from the CD mode to the function mode, and turns off the virtual optical disc drive.

Step 260: The operating system can drive the function circuit of the external device to work.

Please refer to FIG. 1 to FIG. 3 again. The operation of the external device 30 is illustrated as follows. The external device 30 is installed in the host 12 to expand the function of the host 12. When the connector 34 of the external device 30 is coupled to the connector port 24 of the host 12, the operation system of the host 12 can detect the storage device 40, because most operating systems have the built-in driver of the storage device 40. When the storage device 40 starts working, the firmware 42 drives the controller 32 to generate a virtual optical disc drive, and load the image file 44. The host 12 can execute the installation program 46 of the image file 44 to install the driver 48 of the function circuit 36 according to the auto-run mechanism of the virtual optical disc drive. At first the installation program 46 checks if the driver 48 of the function circuit 36 is installed in the host 12. If the driver 48 of the function circuit 36 is not installed in the host 12, the installation program 46 will copy the driver 48 from the image file 44 to the hard disk 22. If the driver 48 of the function circuit 36 is installed in the host 12, the host 12 can drive the function circuit 36 to work.

In conclusion, the external device according to the present invention comprises a controller, a connector, a function circuit, and a storage device. The storage device comprises a firmware and an image file. The image file comprises an installation program and a driver. The external device is coupled to a host via the connector. The firmware can drive the controller to generate a virtual optical disc drive in the host and load the image file to the virtual optical disc drive so as to start the installation program. When the host does not have the driver, the installation program can install the driver in the host. When the host has the driver, the host can drive the function circuit to work. In addition, the storage device can store the manual or application programs of the function circuit. The external device of the present invention utilizes the firmware of the storage device to simulate the auto-run mechanism of the optical disc drive so as to install the drive in the host. Thus, when using the external device of the present invention, the user just couples the external device to the host, and the external device can install the driver automatically without the CD or floppy.

Those skilled in the art will readily observe that numerous modifications and alterations of the device and method may be made while retaining the teachings of the invention.

What is claimed is:

1. An external device with a driver auto-run installation, the external device comprising:
a connector for coupling to a host;
a function circuit for providing a predetermined function to the host;
a storage device comprising an image file, the image file comprising an installation program; and
a controller coupled to the connector, the function circuit, and the storage device, for generating a virtual optical disc drive on the host, and loading the image file to the virtual optical disc drive for executing the installation program.

2. The external device of claim 1, wherein the image file further comprises a driver of the function circuit.

3. The external device of claim 2, wherein the installation program is used to install the driver to the host.

4. The external device of claim 1, wherein the storage device further comprises firmware for driving the controller to generate the virtual optical disc drive in the host, and loading the image file in the virtual optical disc drive.

5. The external device of claim 1, wherein the connector is a universal serial bus (USB) interface.

6. The external device of claim 1, wherein the connector comprises an IEEE 1394 interface.

7. The external device of claim 1, wherein the function circuit is a wireless module for providing a wireless transmission for the host accessing a network.

8. The external device of claim 1, wherein the storage device is a non-volatile memory.

9. A method of installing a driver of an external device, comprising:
coupling the external device to a host;
generating a virtual optical disc drive in the host;
the host reading an image file stored in the external device with the virtual optical disc drive; and
the host executing an installation program in the image file for installing a driver of the external device.

10. The method of claim 9, further comprising:
the host turning off the installation program and the virtual optical disc drive when the host already has the driver.

11. The method of claim 9, further comprising:
the host driving the external device with the driver to access a network through a wireless transmission.

12. The method of claim 9, wherein coupling the external device to the host is coupling the external device to the host through a universal serial bus (USB) interface.

13. The method of claim 9, wherein coupling the external device to the host is coupling the external device to the host through an IEEE 1394 interface.
